(19) United States
(12) Patent Application Publication
(10) Pub. No.: US 2003/0041227 A1
(43) Pub. Date: Feb. 27, 2003

(54) Distributed database system

(76) Inventor: Yoshiki Nakamatsu, Chiba (JP)

Correspondence Address: RABIN & CHAMPAGNE, PC, 1101 14TH STREET, NW, SUITE 500, WASHINGTON, DC, 20005, US

(21) Appl. No.: 10/214,707

(22) Filed: Aug. 9, 2002

(30) Foreign Application Priority Data
Aug. 10, 2001 (JP) 243396/2001

(51) Int. Cl. G06F 7/00

(52) U.S. Cl. 712/200

(57) ABSTRACT

A distributed database system contains a plurality of databases each storing the same common-data and a plurality of servers having at least one the database, and enabling an active program to move in a specified-sequence among these servers, each server comprises a tuple generating means to generate a self-data-tuple related to a common-data to be updated; a tuple attaching means to attach the self-data-tuple to the active program; a update process means to perform each data update process on database at its own side; a update information adding means to add a update information to a said other-data-tuple; and a tuple deleting means to delete said other-data-tuple from the active program.

### FIELD OF THE INVENTION

The present invention relates to a distributed database system.

### RELATED ART

The title of literature: A. Goshinski, “Distributed Operating Systems—The Logical Design”, Addison Wesley

A distributed database is widely used which has copies of data distributed over a plurality of sites to enhance the reliability and availability of the database, shorten access time, and increase throughput.

When a plurality of transactions are likely to concurrently update a distributed database such as mentioned above, there have heretofore been the four methods (1) through (4) as ways of executing updates while preserving the consistency of the database.

(1) All-copy lock method

In this method, a transaction that succeeded in locking all database sites can update data. In fact, the database management system (hereafter referred to as “the DBMS”) at the related site updates data at all sites.

When all of the database sites could not be locked, in other words, if even one site could not be locked, all attempts to set locks on data at all sites terminate (abort).

(2) Majority lock method

In this method, a transaction that succeeded in locking a majority of database sites updates data. In fact, the DBMS at the related site updates data at all the sites. There is a method which assigns different weights to the different sites to decide which site acquires a lock by majority ballot instead of a majority decision by voters having equal weights.

In this method, when locks on more than a half of all sites could not be acquired, locks at all sites abort.

(3) Primary copy method

In this method, a database site as a site for primary data is fixed for each item of data and a lock is placed only on primary data. If a lock is placed successfully on primary data, the DBMS at this site updates data at all sites.

(4) Token passing

According to this method, as shown in FIG. 2, a logical ring is formed by related sites 1 through 6, and a token is passed from the DBMS at one site to the DBMS at an adjacent site (from site 1 to site 2, for example). The DBMS that received the token checks if there is a transaction waiting to update data at its own site, and if there is, updates the data. If a site holds a token, this site has the right to update.

In this method (4), if some data was updated at site 5, for example, each of the DBMSs at other sites performs the same update operation on the same data when the token is passed to it, by which the consistency of data can be preserved.

However, in any of the above-mentioned methods, when a transaction at a site updates data, it is necessary for that site to issue an instruction to update data to all the other sites as shown in FIG. 3, the amount of data traffic is large.

Further, in the methods of (1) and (2), a large amount of traffic is required until a necessary number of locks are set successfully, and if a lock could not be obtained, the attempt to set a lock aborts, and another attempt needs to be made to set a lock.

The method of (3) is simple indeed, but fragile in a sense that if a fault occurs at the site holding primary data, this may leads to stoppage of the whole system. In addition, access tends to concentrate on some sites, which is a problem in respect of efficiency.

Further, in the method of (4), the amount of traffic is relatively small, but when data is updated, the DBMS of the site does not pass the token to another site until the update operation is finished, which results in much delay.

Each of the above-mentioned methods has the problem that in an update operation, workload concentrates on the site where data is updated.

### SUMMARY OF THE INVENTION

To solve the above problem, the present invention adopts the structures which will be described in the following.

<Structure 1>

A distributed database system according to the present invention has a plurality of databases to store data and a plurality of servers at each at least one said database is placed, and enables an active program to move in a specified-sequence among said servers.

In the system, at least two servers have jointly said data as a common-data respectively,

and each said server comprises,

a tuple generating means to, based on a data update request from a client connected to the server, generate a self-data-tuple which consists a specification information for specifying said data to be updated, and a process information indicating process contents of said data;

a tuple attaching means to attach said self-data-tuple to said active program;

an update process means to perform a data update process on database at its own side, based on specification information and process information in said self-data-tuple and in other-data-tuple which is generated by other server and red out from said active program;

and an update information adding means to add, a update information expressing the end of said data update process corresponding to said other-data-tuple, to the said other-data-tuple.

Also, in each server, when said update process means has judged that said database at its own said server has no data corresponding to said specification information in said other-data-tuple, said update information adding means may add said update information to said other-data-tuple.

<Structure 2>

A distributed database system according to the present invention has a plurality of databases each storing the same common-data and a plurality of servers at each at least one said database is placed, and enables an active program to move in a specified-sequence among said servers.

In the system, each said server comprising:

a tuple generating means to, based on a data update request from a client connected to the server, generate a self-data-tuple which consists a specification information for specifying said common-data to be updated, and a process information indicating process contents of said common-data;

a tuple attaching means to attach said self-data-tuple to said active program;

an update process means to perform a data update process on database at its own side, based on specification information and process information in said self-data-tuple and in other-data-tuple generated by other server and read out from said active program;

and an update information adding means to add, an update information expressing the end of said data update process corresponding to said other-data-tuple, to said other-data-tuple.

In the distributed database system according to the present invention, the tuple generating means of each server generates a self-data-tuple related to data update processes taking place at its own side, the tuple attaching means attaches the self-data-tuple to the active program, the update process means performs data update process corresponding to the self-data-tuple or the other-data-tuple, and the update information adding means adds update information to the other-data-tuple.

As described above, for example, when a data update process took place in one server, it is possible to make this data update process equally be carried out in all other servers only by attaching the self-data-tuple related to the data update process to the active program, without sending an update instruction to each other server respectively like the past. Thus, the amount of data traffic can be reduced.

Further, as the active program is moved from one server to next server, the data-tuples formed at every server can be attached and read out by all the other servers. Therefore, in one server, data update processes corresponding to all other-data-tuple can be carried out en bloc. As a result, the process efficiency can be improved.

To mention a single example, suppose that a distributed database system has four servers connected in a ring. The active program that is passed among the four servers contains an update process table for sequentially storing the data-tuples mentioned above. The update process table includes areas for storing update information or update not-yet-complete information.

In this case, if update information showing the end of the data update process is represented by “1”, update not-yet-complete information is represented by “0”.

If a data update process 1 takes place at server 1, for example, to update common-data “A” to “a” in response to an update request from a client, the tuple generating means of the server 1 generates data-tuple 1 consisting of specification information for “A” specifying common-data “A” and process information “a”. The update process means performs a data update process based on the specification information and the process information. The update information adding means adds update information “1” for the server 1 and update not-yet-complete information “0”, “0”, and “0” for the other servers 2, 3 and 4 to the data-tuple 1. In addition, the tuple attaching means writes the respective items of information in the update process table of the active program.

In other words, as the data-tuple 1, a record shown below is written in the update process table.

| | | | The Field | The Field | The Field | The Field |
|---|---|---|---|---|---|---|
| Rec- | The Field of | The Field of | of Update | of Update | of Update | of Update |
| ord | Specification | Process | state of | state of | state of | state of |
| No | information | information | server 1 | server 2 | server 3 | server 4 |
| 1 | Specification | A = a | 1 | 0 | 0 | 0 |
| | information | | | | | |
| | for A | | | | | |

After this, the server 1 moves the active program to the server 2. The data-tuple 1 recorded in the update process table in the active program is a self-data-tuple for the server 1, and is an other-data-tuple for the server 2.

When the update process means of the server 2 performs a data update process to update data “A” to “a” in the database on the server 2 side based on the specification information and the process information of record No. 1, that is, the data-tuple 1, the update information adding means rewrites the update not-yet-complete information “0” relative to its own side to the update information “1”. In other words, in the update process table, the record No. 1 includes “specification information for A”, “a” and state data of “1”,“1”, “0” and “0”.

Herein, corresponding to a data-tuple, one record is formed. However, in other cases, corresponding to a data-tuple, a plurality of records can be formed.

In the server 2, the data-tuple 2 related to the data update process to update common-data “B” to “b”, for example, which takes place on the server 2's own side, can be given to the update process table as in the server 1. At this time, the data-tuple 2, shown below, is added to the update process table.

| | | | The Field | The Field | The Field | The Field |
|---|---|---|---|---|---|---|
| Rec- | The Field of | The Field of | of Update | of Update | of Update | of Update |
| ord | Specification | Process | state of | state of | state of | state of |
| No | information | information | server 1 | server 2 | server 3 | server 4 |
| 1 | Specification | A = a | 1 | 1 | 0 | 0 |
| | information | | | | | |
| | for A | | | | | |
| 2 | Specification | B = b | 0 | 1 | 0 | 0 |
| | information | | | | | |
| | for B | | | | | |

Each server may further comprise a tuple deleting means to delete said other-data-tuple from the active program after it judges that all said update information corresponding to all of the said other servers have been written into the other-data-tuple.

More specifically, in the above example, when the active program is moved to the server 4, for example, and a data update process takes place at the server 4 to update common-data “A” to “a” data for update states of the servers corresponding to the data-tuple 1 become all 1s, which means that the data update process has been completed for all the servers. At this time, the tuple deleting means of the server 4 decides that the data update process to update common-data “A” to “a” has been done at all servers, and deletes the data-tuple 1, that is, record No. 1 from the update process table.

Therefore, the update process table can be utilized efficiently. In other words, information can be attached efficiently to the active program, and the amount of data traffic can be reduced to a minimum level.

Each server may further comprise a lock information attaching means to attach lock information regarding said common-data to be updated to said active program before said self-data-tuple corresponding to the said common-data is generated, and a transfer means to transfer said active program to next said server when the said lock information is attached.

In the above example, the active program may comprise a lock information table for storing lock information. In the server 1, before generating a data-tuple 1 related to a data update process to update common-data “A” to “a”, when the lock information attaching means writes specification information specifying the common-data “A” as data to update and lock information including lock state information for locking the data “A” in the lock information table, the transfer means transfers the active program, which has had the lock information written in it, to the server 2.

In this case, because the active program has the lock information regarding the common-data “A” attached to it, it is impossible for the server 2 to execute a data update process on the common-data “A”.

More specifically, in this example, even if the active program were transferred to any server other than the server 1 before the data-tuple 1 is given to the active program at the server 1, the data update process to the common-data “A” is disabled by the lock information on the common-data, which has been written in the active program.

Therefore, by making use of the update process time of a piece of common-data, for example data “A”, in one server, for example the server 1, it is possible to move the active program from one server to another to have some other practicable data update process, except for an update of data “A”, in another server. In this way, total data update process time can be reduced and concurrency of processes can be increased.

### BRIEF DESCRIPTION OF THE DRAWINGS

FIG. 1 is a schematic diagram showing a structural example of the main components of a DBMS used in a distributed database system according to a first and a second embodiment of the present invention;

FIG. 2 is a schematic diagram showing an example of a general structure of a ring formed by sites;

FIG. 3 is a diagram for explaining the operation of the ring formed by the sites;

FIG. 4 is a schematic diagram showing a list of addresses used in the first and the second embodiment;

FIGS. 5(a) and 5(b) are diagrams showing the items of the update content queues according to the present invention;

FIG. 6 is a flowchart showing the operation of an active program according to the first embodiment;

FIG. 7 is a flowchart showing the operation of the DBMS according to the first embodiment;

FIG. 8 is a schematic diagram showing a structural example of a list of locks used in the second embodiment;

FIG. 9 is a flowchart showing the operation of an active program according to the second embodiment; and

FIG. 10 is a flowchart showing the operation of the DBMS according to the second embodiment.

FIG. 11 is a block diagram showing a distributed database system according to the present invention.

FIG. 12 is a data structure diagram showing a update content queue table.

### DESCRIPTION OF THE EMBODIMENTS

First Embodiment

A first embodiment of a distributed database system for a distributed database according to the present invention will be described with reference to an example in which the DBMS of each database server provides relational models.

The Structure of First Embodiment

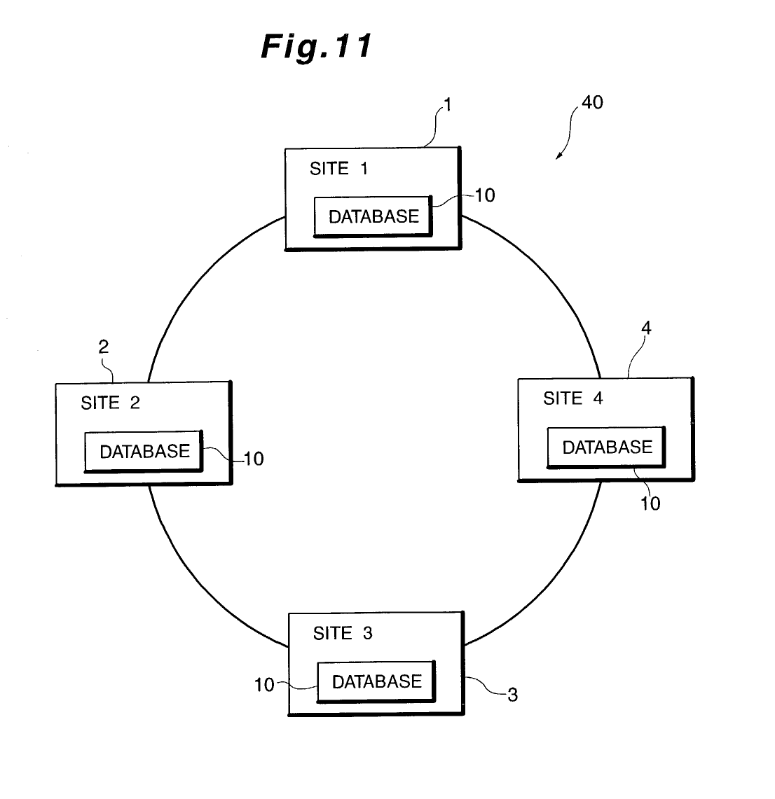

FIG. 11 is a block diagram showing an embodiment of a distributed database system according to the present invention.

As shown in FIG. 11, a distributed database system 40 of the present invention includes four servers, that is, sites 1, 2, 3 and 4. These sites 1˜4 are connected via communication lines each other. In each site (1,2,3 or 4) data base 10 storing one or more than one common data, is being placed. It ought to be noted that in this embodiment, the databases 10 also may store non-common data besides common data.

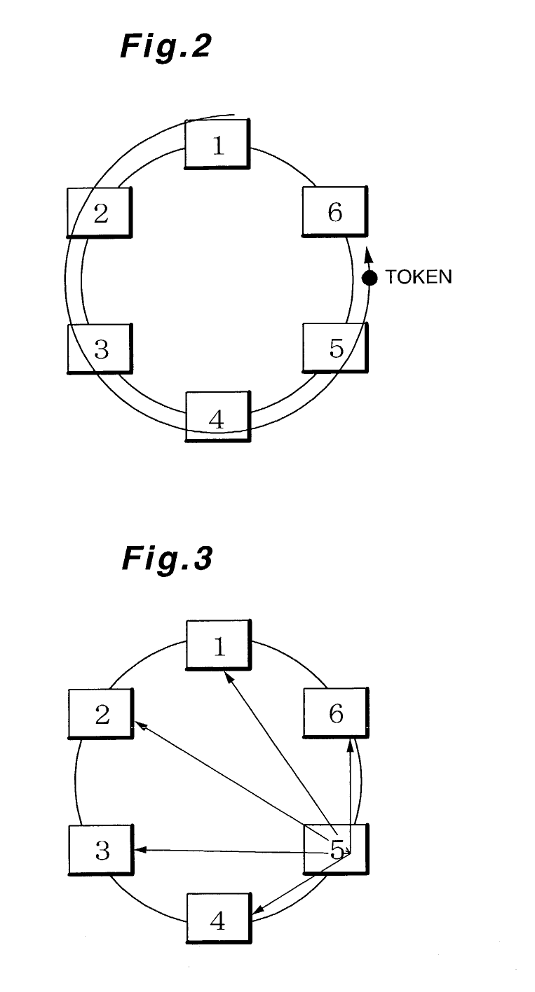

An example of the whole logical structure of the distributed database system according to the first embodiment may be a logical ring network on which the sites are connected in a closed loop in the same manner as shown in FIG. 2. Note that because two or more database servers may exist in one site, the database servers may not necessarily be provided on one-to-one correspondence with the sites in this network, but it is supposed here that there is only one database server in each site.

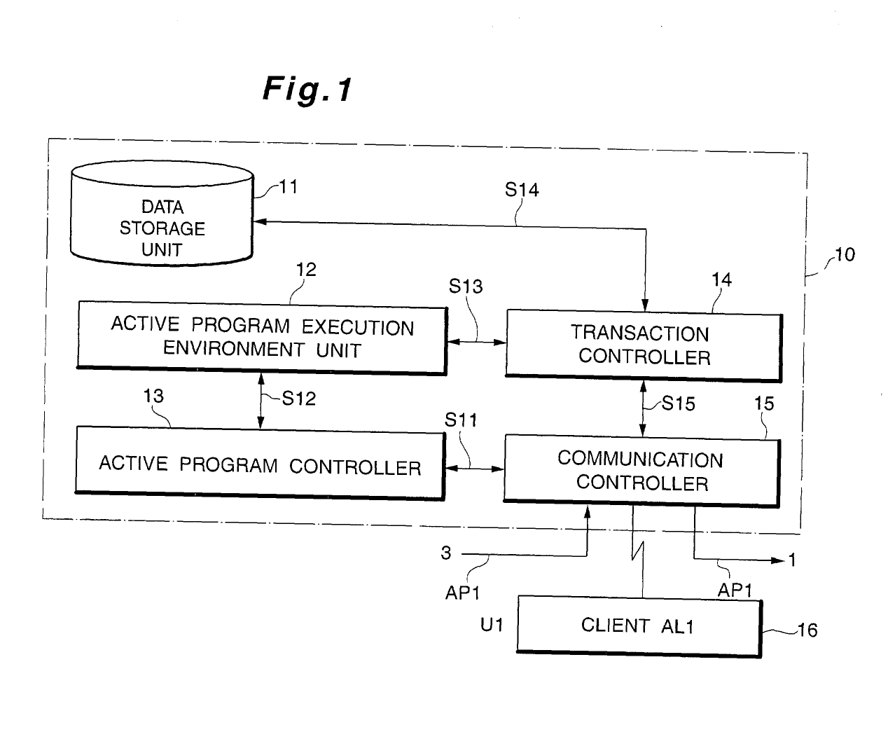

The database server of each site has a DBMS 10 of substantially the same structure. A structural example of the main components of the DBMS 10 is shown in FIG. 1.

A Structural Example of DBMS

In FIG. 1, the DBMS 10 comprises a data storage unit 11, an active program execution environment unit 12, a transaction controller 14, an active program execution controller 13, and a communication controller 15.

Among these components, the data storage unit 11 is a physical database for storing actual data. In this embodiment corresponding to a relational model, because the data storage unit 11 is a relational database, data is stored in a two-dimensional table (in other words, a relation). The data storage unit 11 at each site may be a fragment of the same logical database. Fragments are generated by dividing a relation of a logical database by projection or a constraint.

Not all of data stored in the data storage unit 11 needs to be stored at the data storage units at other sites, but in the case of a distributed database, it is necessary to store at least part of data at other sites. The advantages of higher throughput, enhanced reliability and improved availability of a distributed database cannot be obtained until the same data is stored in multiple computers (namely, in database servers).

The communication controller 15 is connected to a plurality of clients. Among them, a client 16 is a part which starts an application AL1 in response to a request of a user U1. The application AL1 requests the DBMS 10 to perform data manipulation (a request to retrieve, update, for example) on data stored in the data storage unit 11.

Not only to a client, the communication controller 15 as a transfer means has a function to send or receive a movable active program AP1, which will be described later, to or from the DBMSs at other sites (at site 1, for example, if the communication controller 15 under discussion is in the DBMS at site 4), and circulate the active program among the sites. Supposing that the ring is formed by four sites for simplicity's sake and the active program AP1 is circulated by being repeatedly transferred from site 4→site 1→site 2→site 3→site 4→ . . . , the DBMS 10 at site 4 receives the active program AP1 from the DBMS at site 3 and sends the active program AP1 to the DBMS at site 1.

Then, the transaction controller 14 is a part which executes a transaction in response to a request of the client 16 to manipulate data. The transaction here is one or a series of data-manipulation operations executed in response to a data manipulation request from the client 16. A data-manipulation operation includes a write operation, a read operation, and so on.

The transaction controller 14 comprises a function to generate a self-data-tuple consisting of specification information for specifying data (shared or unshared) to update and process information showing contents of process on data, to the other sites in response to a data update request from a client directly connected to its own site, a function to execute a data update process on the database of its own side based on specification information and process information in the self-data-tuple and the other-data-tuples generated by the other sites, the tuples being read out of the active program, and a function to add update end information showing the end of the data update process to the other-data-tuples when the transaction controller 14 decides that the data update process corresponding to other-data-tuples has ended at its own site or decides that there is no data specified by the specification information in the database of its own site according to the specification information in other-data-tuples.

The transaction controller 14 may have a function to add lock information on data to update to the active program before a self-data-tuple is generated. When this lock information is imparted to the active program, the transmission controller 15 transfers the active program to the next site.

It is necessary for a client to be able to manipulate the above-mentioned database and data independently of how the above-mentioned fragment was generated or whether each item of data is stored in the data storage unit (11) at each site. Therefore, a request from the client for data manipulation of the above-mentioned logical database is automatically converted into a transaction on each fragment (the storage unit 11 at each site).

In a distributed database, multiple transactions are executed in parallel (by turns) or serially. A serial execution of transactions is such that when the final state of data obtained by executing the transactions concurrently perfectly coincides with the final state of data obtained after executing transactions singly in such a way that after all operations of the first transaction have been executed, the operations of the second transaction are started, and after all the operations of the second transaction have been executed, the operations of the third transaction are started, and so on.

Regardless of whether the operations are executed in parallel or serially, the final state of data is exactly the same.

Because the execution of a read operation in a transaction does not cause any change in stored data, a conflicting (exclusive) relationship does not occur between the read operations, but a conflicting relationship can occur between the write operations or between a read operation and a write operation. It is necessary to keep a fixed order of execution of operations in conflict.

The active program execution controller 13 is a part which passes the active program AP1, after receiving it from the communication controller 15, to the active program execution environment unit 12, and controls the active program execution environment unit 12 to automatically start the program.

The active program execution environment unit 12 may have a function to impart the self-data-tuple stated above to the active program and a tuple deleting function to delete other-data-tuple stated above from the active program when the update end informations corresponding to all of the other servers are written into the other-data-tuple.

Generally, an active program indicates a software program to perform some task while it is transmitted from one node to another. To reduce the size of a program transmitted and improve the maintainability of the module in common use, it is a general practice to provide a program module to be preinstalled at each site. When a program module has been preinstalled, the active program is executed while reference is made to the preinstalled program module. A program to be preinstalled is downloaded from the server for program modules. This program module is used as a component of the active program execution environment unit 12.

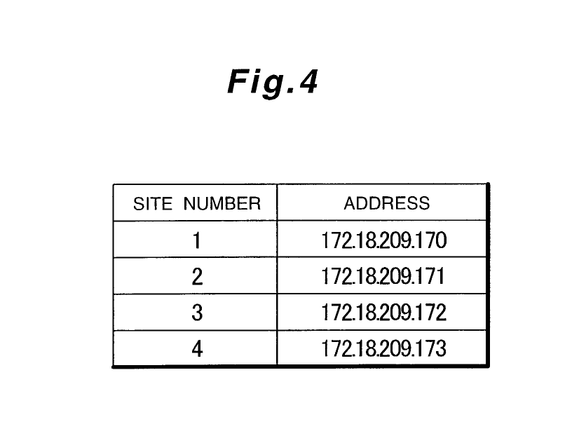

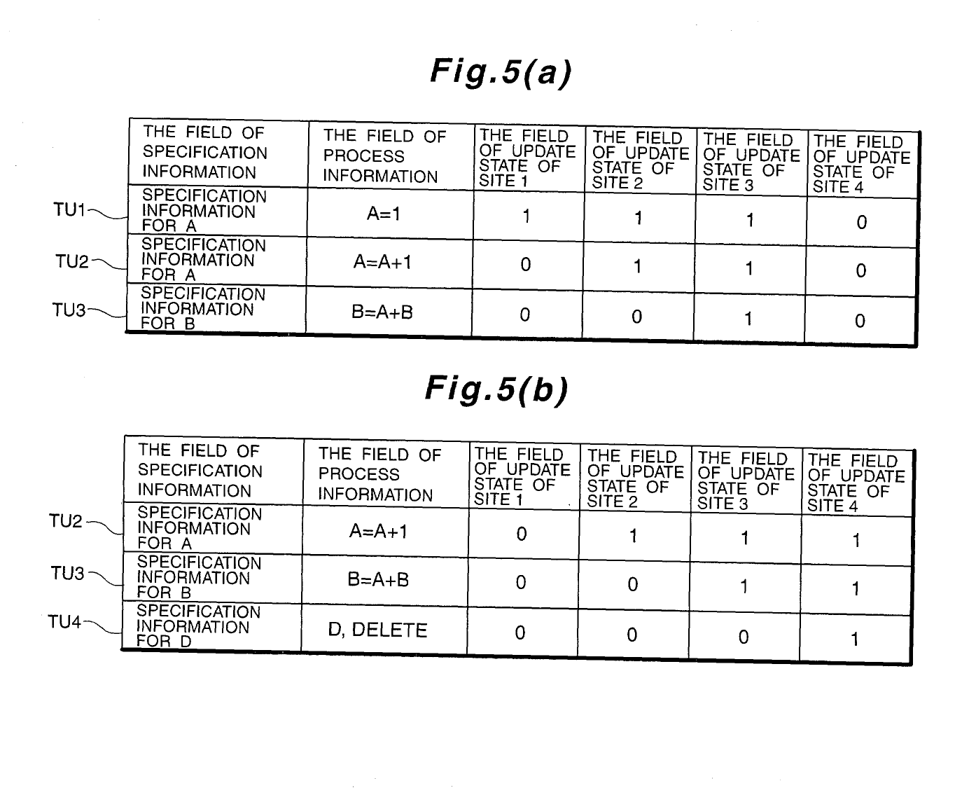

The active program AP1 includes a list of addresses shown in FIG. 4 and a data structure in an update content queue shown in FIG. 5 (a) and 5 (b), and also includes codes (the codes may be in the state of an intermediate code, for example) to execute processes corresponding to the update contents queue, for example, in collaboration with the program module.

The update content queue shows the update contents in a broad meaning (the alteration, insertion and deletion of data, for example). The processes corresponding to the update content queue are a read operation, a write operation, a deletion operation, etc. for the data storage unit 11, which are executed in accordance with the update content queue. Note that it is very likely that a deletion operation is an operation physically equal to a write operation (to write a bit pattern that means invalidity, for example) depending on the size of data to be deleted or the function of the DBMS 10 mounted).

There are a number of possible methods to realize an update contents queue, but it is a general practice to logically realize it using a list structure.

In FIG. 4, site numbers 1˜4 are numbers by which to identify the sites (in other words, the database servers), and the addresses indicate the addresses of the sites. Fig. shows as an example the IP addresses expressed in dotted decimal notation. A specified address (172.18.209.171, for example) can be used to identify the address of a site to transmit an active program AP1 to from one's own site to circulate it between site 1 and site 4.

In FIG. 5, the data “A”, “B” and “D” in specification information item as objects of operations, are stored in no fewer than two sites in the sites 1˜4. FIG. 5 shows only data as updated objects obtained by using a write operation or a delete operation and stored in the data storage unit 11.

The stored items of process information in the update content queues shown in FIGS. 5(a) and 5(b) are “A=1”, “A=A+1”, “B=A+B” and “D, delete”.

FIG. 5(a) shows the update contents queue at the moment the active program arrives at the site 4. On the other hand, FIG. 5(b) shows the update content queue at the moment the active program leaves the site 4.

The 4×4 update state matrix LG on the right side of the update contents column represents whether updating of each data item has been completed, namely, the update state at each of sites 1˜4, which corresponds to summary of log information at each site. In the update state matrix LG, the update state of 1 indicates that data has been updated, and the update state of 0 indicates that data has not been updated.

Therefore, by collating the above-mentioned order of circulation (4→1→2→3→4→ . . . ) with the contents of the update state matrix LG, it is understood that a tuple TU1, which consists of data A, data content 1, and the update states of 1110 as shown in FIG. 5 (a), is a tuple generated by a write operation as a component process of the transaction at site 1, that though the update operations have been completed, 1 is set in the update state fields at site 2 that received the active program AP1 after the site 1 and also at site 3 that received the AP1 after the site 2, but it is understood that at site 4 that has just received the active program AP1, an update operation has not been completed, and therefore 0 is still set in its update state field.

Because the tuple TU1 is generated and written in the update content queue at the site 1, it is the site's own data tuple for the site 1, but it is one other-data-tuple for the other sites 2, 3 and 4.

Similarly, it is obvious that referring to other tuples TU2˜TU4, the tuple TU2 is a tuple generated by a write operation as a component process of a transaction at site 2, and the tuple TU3 is a tuple generated by a write operation as a component process of a transaction at site 3, and the tuple TU4 is a tuple generated by a write operation as a delete operation (write operation) which is a component process of a transaction at site 4.

The tuples corresponding to data that were updated at all sites 1˜4 are deleted from the update content queue. For example, under the conditions shown in FIG. 5(a), the update state in the tuple TU1 is 1110, and when this update state becomes 1111 by completion of updating at site 4, it follows that with regard to the update content 1 of the data item A, the consistency of data could be confirmed at sites 1˜4, with the result that the tuple TU1, including the corresponding row of the update state matrix LG (the row having 1110 in the condition shown in FIG. 5), is deleted. After this, the tuple TU4 is added by the delete operation at the site 4, and the update content queue becomes the state as shown in FIG. 5(b).

It is better to arrange for the contents of data, such as obtained by a read operation to be returned to the application AL1 on the client 16 by putting them together when one transaction is committed (that is, terminated normally).

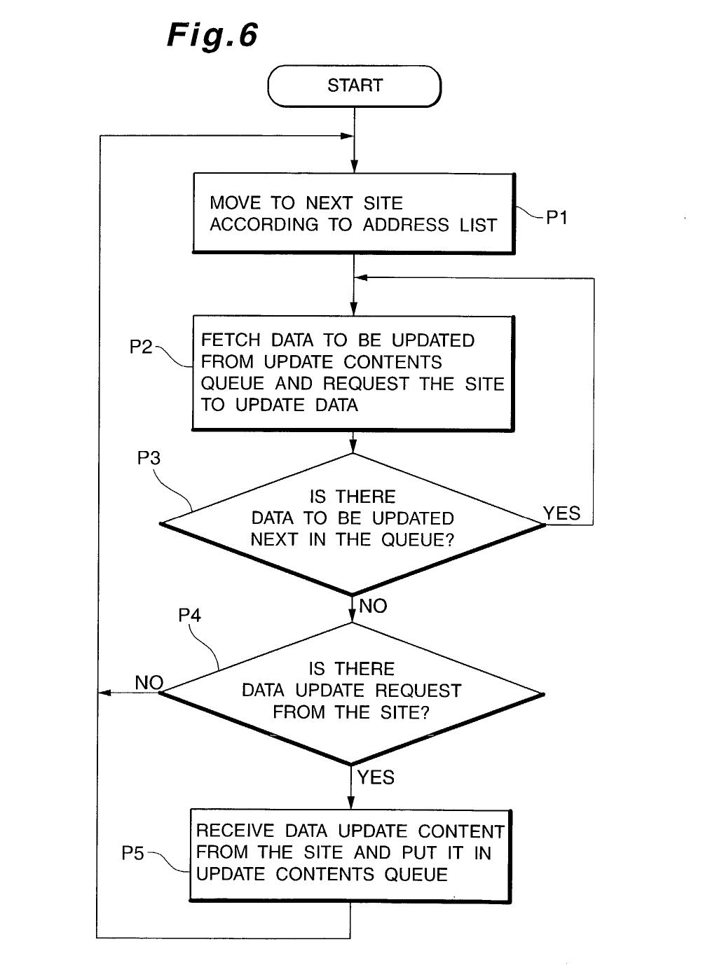

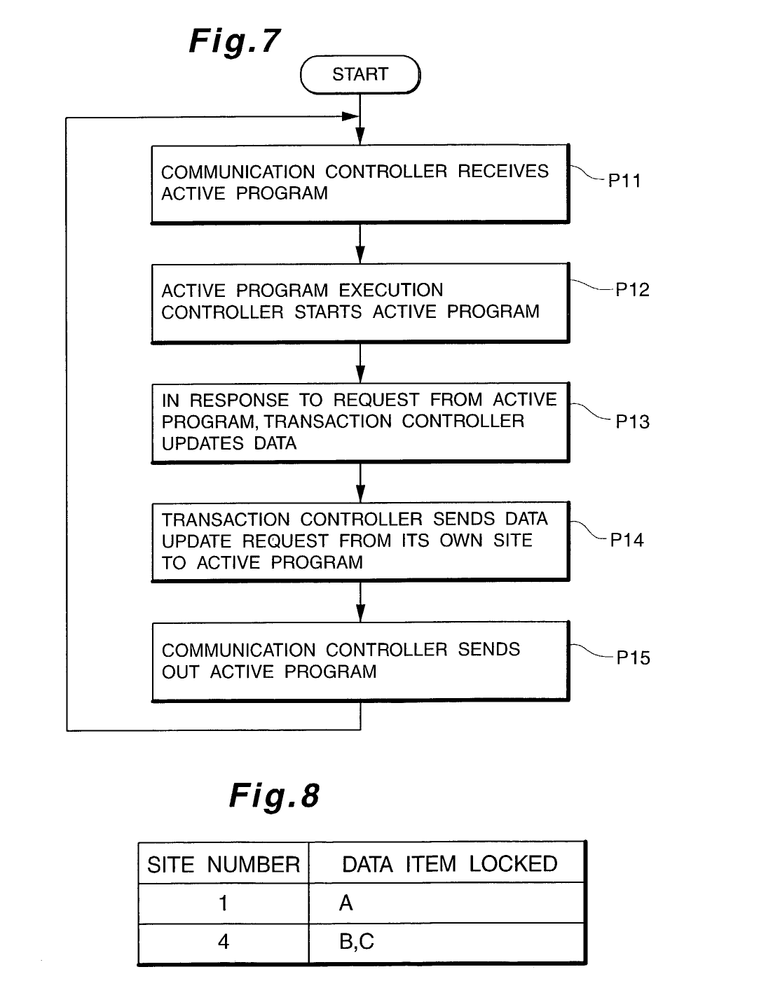

The operation of the first embodiment structured as discussed above will be described with reference to the flowcharts in FIGS. 6 and 7.

The flowchart in FIG. 6 consists of steps P1˜P5, and the flowchart in FIG. 7 consists of steps P11˜P15.

The Operation of the First Embodiment

FIG. 6 is the flowchart showing the process executed by the active program AP1. FIG. 7 is the flowchart showing the process of the DBMS 10 when it receives the active program AP1. The two flowcharts are formed from different viewpoints about exactly the same process.

In FIGS. 6 and 7, the active program AP1 moves by itself to the next site according to the list of addresses in FIG. 4 held inside it (P1). It ought to be noted, however, that this move is, of course, realized by support from the active program execution environment unit 12 and the communication controller 15 (P15 at site 3).

Suppose that by the above-mentioned move from the DBMS at site 3, the active program AP1 arrived at the DBMS 10 at site 4 shown in FIG. 4. The active program AP1 that arrived at the DBMS 10 is transferred through the communication controller 15 to the active program execution environment unit 12 where the active program AP1 is started automatically (P11, P12).

Thus, the active program AP1 refers to the update content queue held in it, fetches data to be updated one after another starting from the top row of the queue, requests the DBMS 10 to update the specified data, and the transaction controller 14 of the DBMS 10 complies with this request (P13). Under the conditions shown in FIG. 5 (a) , because the tuple TU1 is at the top of the queue, it is therefore requested that the specified data be updated in the order of TU1, TU2 and TU3.

The specified data is not necessarily managed by the DBMS 10 at site 4 (in other words, this data may be stored in the data storage unit 11), for which reason when an update request is made, a non-existence error may occur. If a non-existence error occurs, the update process is finished in a pseudo normal termination, and the update state is set to 1 in the same manner as when updating of the relevant tuple was terminated normally. The reason for this is that unless the update state is set to 1 when a non-existence error occurs, inconveniences arise, such as the size of the update content queue increasing to a boundless extent as the active program AP1 circulates repeatedly.

For example, when the DBMS 10 at site 4 manages data A and data D shown in FIG. 5 but does not manage data B, at step P2 the active program execution environment unit 12 makes a request to write 1 over the data A in the tuple TU1 in the first place and this updating is carried out, the update state of the tuple TU1 becomes 1111, whereupon the tuple TU1 is deleted.

Then, because at step P3 there is the specified data to be updated in a tuple TU2, the process branches out to the Yes side from the step P3, and the active program execution environment unit 12 makes a request to update data in the tuple TU2 (P2). When this updating is executed, the update state at site 4 is switches from 0 to 1. Therefore, the update state of the tuple TU2 changes from 0110 to 0111. Because an update has yet to be carried out at site 1, the tuple TU2 is not deleted.

Again at step P3, there is the specified data to be updated in the tuple TU3, the process branches out to the Yes side, and after updating is executed, the update state at a related site is set to 1.

Because there is not any other tuple beyond the tuple TU3 (at this point in time, a tuple TU4 has not yet been generated), the process branches out to the No side this time, and proceeds to a step P4.

At step P4, it is confirmed whether or not there is a request from the site (site 4 in this case) to update data. If there is not, the process branches out to the No side and the active program AP1 is transmitted to site 1 as the next site of the circuit, or if there is a request, the process branches out to the Yes side and the process at step P5 is executed.

In FIG. 5 (b), this corresponds to a case where, at the site 4, a transaction including the deletion of data D (a write operation) is supplied from an application AL1 on a client 16.

When it has been clear that the data D exists only in the data storage unit 11 held in the DBMS 10 at site 4, and the data D does not exist in the data storage units at sites 1˜3, even if the data D is deleted, it is not necessary to put the related tuple TU4 in the update content queue.

Note here that regardless of whether it has been made clear or not that the data D exists in the data storage unit held in the DBMS at any other site than the site 4, because there is a slight possibility that the data D exists, the related tuple TU4 is stored at the bottom of the update content queue at a step P5. In the condition shown in FIG. 5 (b) , because the data D at site 4 has been deleted, the update state of the tuple TU4 is 0001.

When a transaction, including deletion of the data D at the site 4, further includes operations for data manipulation other than deletion, subsequent tuples as many as the number of those operations are generated below the tuple TU4. At this point in time, the update states of those tuples are 0001, the same as in the tuple TU4.

In this case, the data-manipulation operation included in that transaction is only one, and besides the update of the tuple TU4, there is no other update request from a client (16, for example) for an update to be put in the update content queue, and the process proceeds to the step P1.

At the site 1 that receives the active program AP1 from the site 4 at the step P1 and at the sites 2 and 3 that will subsequently receive the active program AP1, the same process as described above is executed according to the flowcharts of FIGS. 6 and 7.

Because the order of sites through which the active program AP1 is circulated is fixed, it is obvious that the above-mentioned serializability can be secured by the process described above.

Meanwhile, each DBMS executes a transaction process from the client at its own site. The transaction is executed by using two-phase locking. In two-phase locking, prior to the process of operations in a conflict relationship, all necessary data is locked, and after the completion of the process, all locked data is unlocked.

In executing a transaction, while an active program AP1 has not been received, when a transaction requests a lock, the process of this transaction is blocked, and when an active program AP1 is received, the process in FIG. 7 is executed.

The transaction process that has been blocked is executed to the end at step P14 in FIG. 7 because all necessary locks can be acquired when the DBMS receives an active program AP1. If the transaction process includes an update of data, updates data at the site, and then sends a data update request from that site to the active program AP1. Accordingly, one or more new tuples are generated in the update content queue in the active program AP1 in response to the data update request.

In the update content queue in FIG. 5, each of the tuples TU1˜TU4 may be looked on as a tuple corresponding to one transaction. In that case, each transaction is a simple one that includes only one operation on data.

Let us consider a little more complicated case that one transaction includes multiple operations of data, an example of which are transactions TR1˜TR4 shown below. Incidentally, the process of a transaction executed in response to a data manipulation request received from a client at some site is executed in parallel with the processes of transactions TR1˜TR4 at the respective sites.

Site 1: the transaction TR1 consists of three steps: lock data A, update data A, and unlock data A.

Site 2: the transaction TR2 consists of three steps: lock data A and B, update data A and B, and unlock data A and B.

Site 3: the transaction TR3 consists of three steps: read data C, set a lock data A, update data A, and unlock data A.

Site 4: the transaction TR4 consists of three steps: lock data B and C, update data B and C, and unlock data B and C.

Herein, data A, B and C as common data are stored in all sites 1˜4.

In the transaction TR1 that the site 1 receives from a client, an update operation WA1 on data A is executed; in the transaction TR2 that the site 2 receives from a client, an update operation WA2 on data A and an update operation WB1 on data B are executed; in the transaction TR3 that the site 3 receives from a client, a read operation RC1 on data C and an update operation WA3 on data A are executed; and in the transaction TR4 that the site 4 receives from a client, an update operation WB2 on data B and au update operation WC1 on data C are executed.

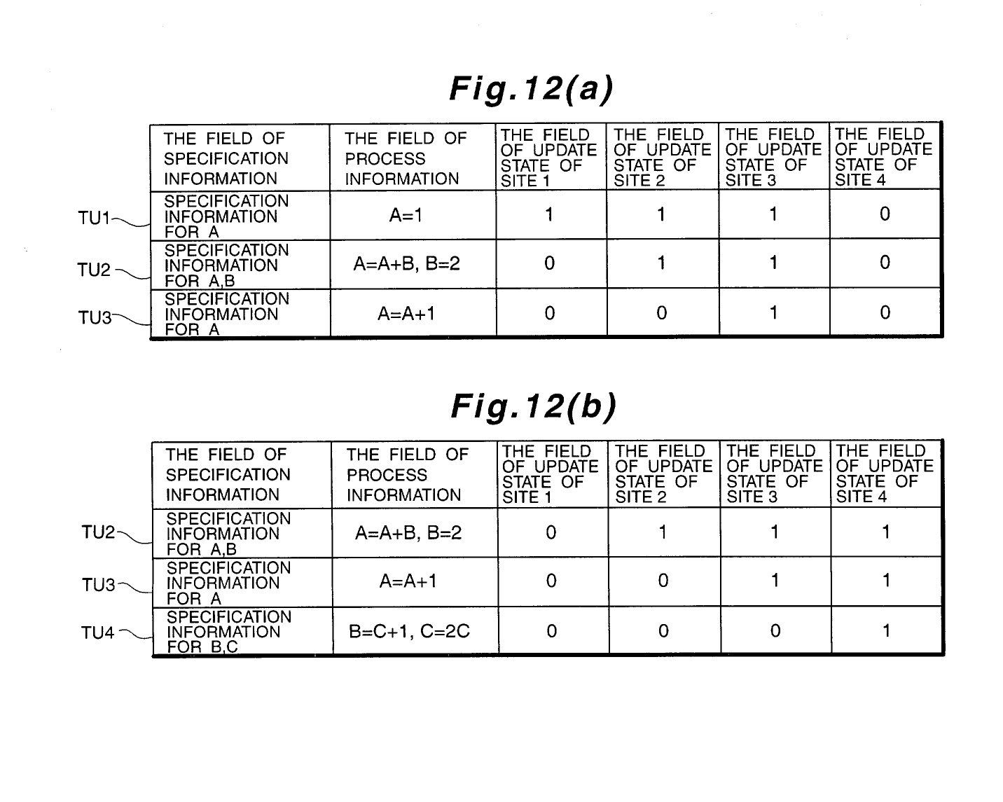

Corresponding to these transactions TR1˜TR4, Four data-tuples Tu1˜Tu4 shown as FIG. 12 (a) and 12 (b), are formed and stored update contents quene-table.

Suppose that the active program AP1 is circulated in the order of site 1→site 2→site 3→site 4→site 1 (times t1˜t7 described below do not represent equally spaced times, but represent the points in time when the active program AP1 moves). The processes described below are those which are executed at steps P2, P3, P13 and P14.

Time t1: The active program AP1 moves to site 1. The site 1 executes an update operation WA1 on data A. At this time, a tuple of the update operation WA1 is added to the bottom of the update contents queue.

At site 3, data C need not be locked if a read operation of data C does not conflicts with other operations. Therefore, at this point in time, a read operation RC1 can be performed on data C, by which a part of the transaction TR3 is finished.

A premise is made here that data A, B and C are held at all sites 1˜4, but such a premise cannot be made for distributed databases in general and it is necessary to search other sites for data C to detect it reliably. This is because, for example, there is a possibility that data C does not exist in the data storage unit at site 3 but exists in a data storage unit at some other site (site 1, for example).

The operations in the transactions TR1˜TR4, except for the read operations RC1 on data C, are all in conflicting relations, and therefore it is essential to place a lock on necessary data in advance, and the related transaction process is blocked until the active program AP1 is received.

Time t2: The active program AP1 moves to site 2. In response to a request from the active program AP1, the transaction controller 14 at site 2 updates data A in accordance with the update operation WA1 by site 1. After this, the transaction controller 14 resumes the process that has been blocked, and executes the update operation WA2 on data A and the update operation WB1 on data B. At this time, tuples of the contents of the update operations WA2 and WA1 are added in this order to the bottom of the update contents queue.

Time t3: The active program AP1 that contains the update content queue moves to site 3.

In response to a request from the active program AP1, the site 3, by its transaction controller 14, executes an update operation WA1 by site 1 to update data A, an update operation WA2 by site 2 on data A, and an update operation WB1 by site 2 to update data B in order to update corresponding data at site 3, and then resumes the process that has been blocked, and executes an update operation WA3 to update data A.

Even though no changes occur in the content of data C in a read operation RC1, but there is a possibility that the entity of data C does not exist in the data storage unit at site 3. Therefore, at site 3, not only a tuple corresponding to the update operation WA3 but also a tuple corresponding to the read operation RC1 may be put at the bottom of the update content queue as necessity requires. In this case, a tuple for the read operation RC1 and a tuple for the update operation WA3 are arranged in this order in accordance with the transaction TR3.

If effective data C for the read operation PC1 could be obtained at a site where there is a storage unit holding the entity of data C, the content of the data C is sent separately to the site 3.

Time t4: The active program AP1 that has the update content queue including a tuple of the update operation WA1 moves to site 4. In response to a request of the active program AP1, the site 4, by its transaction controller 14, executes the update operation WA1 by site 1 to update data A, the update operations WA2 and WB1 by site 2 to update data A and B, and the update operation WA3 by site 3 to update data A in order to update corresponding data at site 4, and then resumes the process that has been blocked, and executes the update operation WB2 to update data B and the update operation WC1 to update data C. Tuples of the contents of the update operations WB2 and WC1 are added in this order to the bottom of the update contents queue.

By the process at the site 4, the result of the update operation WA1 on data A at the site 1 has been reflected in the data storage units at the sites 1˜4, and the consistency of data related to the update operation WA1 could be ensured, and therefore the tuple for the update operation WA1 (at the top of the queue) is deleted from the update contents queue.

Time t5: Upon removal of the above-mentioned tuple, the active program AP1 containing the update contents queue, to which the tuples of the update operations WB2 and WC1 were added, moves again to site 1.

In response to a request from the active program AP1, the site 1, by its transaction controller 14, executes the update operations WA2 and WB1 to update data A and B by site 2, the update operation WA3 to update A by site 3, and the update operations WB2 and WC1 to update data B and C by site 4 in order to update corresponding data at site 1. By the process of site 2, the results of the update operations WA2 and WB1 of site 2 are reflected in the data storage units at all sites 1˜4, and the consistency of data A and data B related to the update operations WA2 and WB1 is preserved. Therefore, the tuples for the update operations WA2 and WB1 (the tuples at the top of the queue) are deleted from the update content queue.

If, at this point in time, a request is received from the client at the site 1 to execute a new transaction subsequent to the transaction TR1, the process corresponding to the transaction is executed, and a new tuple is added to the bottom of the update content queue. However, suppose that there is no request for a new transaction.

Time t6: The active program AP1 that contains the update content queue after removal of the two tuples makes a move to site 2 for the second time (the second circuit).

In response to a request from the active program AP1, the site 2, by its transaction controller 14, executes the update operation WA3 to update data A by site 3, and the update operations WB2 and WC1 to update data B and C by site 4 in order to update corresponding data at site 2. By this process, the update operation WA3 by site 3 is reflected in date at all sites 1˜4, and the consistency of data A associated with the update operation WA3 is preserved. Therefore, the tuple for the update operation WA3 is removed from the update content queue.

If, at this point in time, there is a request from a client for a new transaction subsequent to the transaction TR2, the process for this transaction is executed, and a new tuple is added to the bottom of the update content queue. It is supposed that there is no request for a new transaction.

Time t7: The active program AP1 moves to site 3.

In response to a request from the active program AP1, the site 3, by its transaction controller 14, executes the update operations WB2 and WC1 by site 4 to update data B and C. By this process, the update operations WB2 and WC1 by site 4 to update data B and C are reflected in the data storage units at all site 1˜4, and the consistency of data B and C associated with the update operations WB2 and WC1 is preserved. Therefore, the tuples of the update operations WB2 and WC1 are removed from the update content queue.

If, at this point in time, there is a request from the client at the site 3 for a new transaction subsequent to the TR3, the process for the transaction is executed, and a new tuple is added to the bottom of the update content queue. Here again, It is supposed that there is no request for a new transaction.

In this case, by the processes up to time t7, the update content queue of the active program AP1 becomes empty, but the active program continues circulating among the sites 1˜4 so as to be able to cope with request for new transactions at any time.

By the by the above-mentioned procedure of execution, the order of serializing the transactions related to updates is such that site 1→site 2→site 3→site 4, by which the consistency of databases (the data storage units 11) of all data stored is preserved.

In the above description, the active program AP1 is circulated in the order of 1→2→3→4 among the sites, but the order may be changed dynamically if necessary. For example, if a fault occurred at site 2, the active program AP1 is transmitted from site 1 to site 3 and the active program AP1 can be circulated through the network exclusive of site 2 until the ring network is restored to normal.

The site at which the active program AP1 starts to circulate may be decided by an instruction issued by a management center, which is established to manage all sites, for example.

In this embodiment, if the same data is stored at as many sites as possible, this increases possibilities that the data can be manipulated even faults occur in multiple sites.

Effects of First Embodiment

According to this embodiment, the amount of traffic and the amount of delay attending on updates can be reduced by making an update request to and executing an update operation at the same site concurrently, performing multiple updates grouped together, and obviating the need to make long-distance communications for updates, for example. Updates are serialized in the active program to preserve the consistency of data.

In this embodiment, a specific site is not fixed for each item of data unlike in the primary copy method mentioned above, and even if a fault occurred in some site, the whole distributed database system can maintain its performance at substantially the same level as before the fault occurred, and is therefore superior in terms of toughness.

Further, according to the present embodiment, workload does not concentrate on one site where an update process is started in an update operation, so that the workload is reduced.

<Second Embodiment>

Description will be made only of differences of the second embodiment from the first embodiment. The first embodiment occupies the active program AP1 till the end of a transaction, so that the granularity of locks that decides the manipulation unit of concurrent transactions is rough, resulting in the data consistency being preserved but concurrency being reduced.

The second embodiment is characterized by a smaller granularity of locks to allow for higher degrees of transaction concurrency and greater throughputs.

Structure and Operation of the Second Embodiment

The main parts of the distributed database Management System in the second embodiment are identical with those of the first embodiment shown in FIG. 1.

Note that the active program AP1 used in the second embodiment has the list of addresses shown in FIG. 3 and the update contents queue shown in FIG. 5 in the first embodiment, but it differs in that it holds a list of locks shown in FIG. 8.

In FIG. 8, the lock list shows site numbers holding a lock or locks on data and the data items currently locked. The current site holding the active program AP1 can set locks only on data items which are not included in the lock list, but those sites not holding the active program AP1 are not allowed to set any data items.

Under the conditions in FIG. 8, the site 1 holds a lock on data A, and the site 2 holds data B and C. Because locks are used originally not for sites, but for transactions, the lock set on data A is a lock for a transaction corresponding to a data manipulation request that the site 1 received from a client, and the locks set on data B and C are the locks for a transaction corresponding to a data manipulation request that the site 2 received from a client. Needless to say, the lock set on data B and the lock set on data C by the site 2 may be the locks for separate transactions.

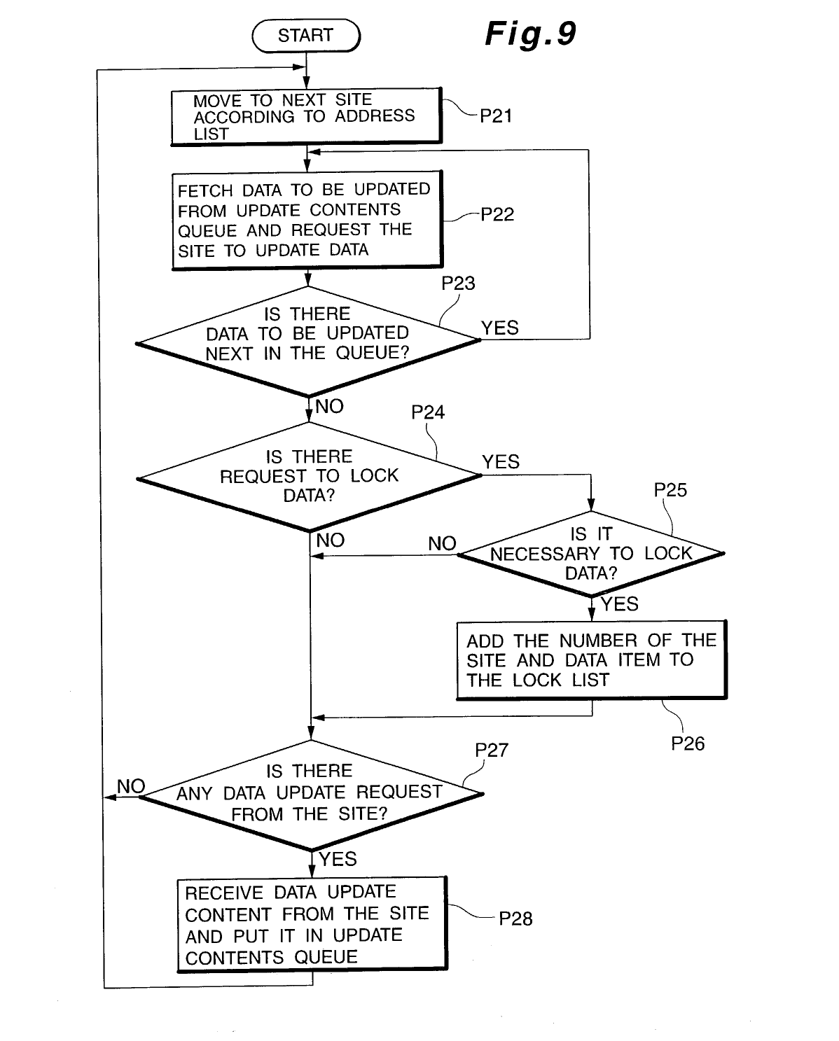

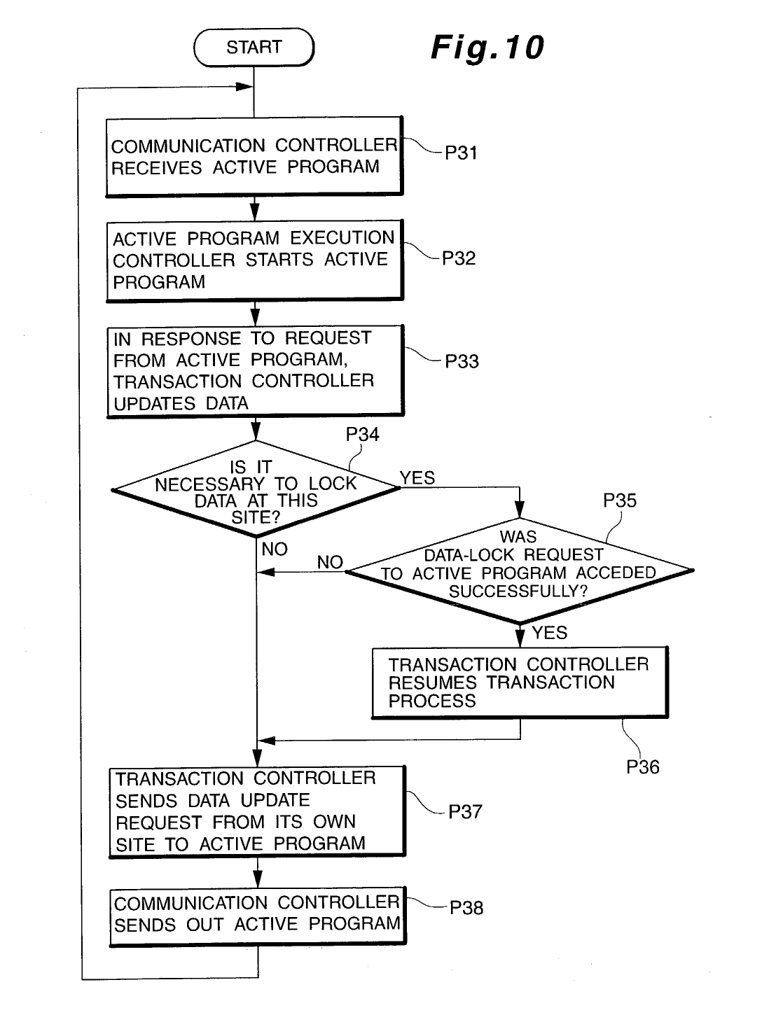

Description will be made of the operation of the second embodiment with reference to FIGS. 9 and 10.

FIG. 9 is a flowchart showing the operation of the active program AP1, and FIG. 10 is a flowchart showing the operation of the DBMS when it receives an active program AP1. The flowchart in FIG. 9 is formed by steps P21˜P28, and the flowchart in FIG. 10 is formed by steps P31˜P38.

In FIGS. 9 and 10, according to the list of addresses held in the active program AP1, the active program AP1 moves by itself to the next site (P21). Note that, needless to say, this move is realized by support from the active program execution environment unit 12 and the communication controller 15 (P38).

After this, by referring to the update contents queue held in the active program AP1, the active program AP1 fetches data to be updated one after another starting from the top of the queue, and requests the DBMS 10 of the site, to which it moved, to update that data (P22). The active program execution environment unit 12 fulfills the request by automatically starting the active program AP1 received.

A tuple is removed from the update contents queue because the update process is finished in a pseudo normal termination when a non-existence error occurred and the update state is set to 1, and the update states at all sites are set to 1. Those operations are repeated until the update contents queue runs of unprocessed tuples. Those steps are the same as in the first embodiment (P23, P33).

Subsequently, at step 24 or 34, the active program AP1 queries the DBMS 10 at its current site as to whether there is a request for a lock on data, and if there is a request, the process branches out to steps P25 and P35, or if there is not a request, the process branches out to a step P27 or P37. At this time, the transaction controller 14 in the DBMS 10 decides if it is necessary to lock data, and if it is necessary, outputs a data lock request.

At the steps P25 and P35, the active program AP1 receives from the DBMS 10 information about data to place a lock on, and decides if it is possible to lock the data based on the above-mentioned list of locks, and if the data item related to the request already exists in the lock list, decides that to place a lock on the data is impossible, and returns an error signal, and the process branches to a step 27 or P37, but if to lock the data is possible, the process branches to a step 26 or 36.

At the step 26, the active program AP1 adds the data item related to the request and the site number to the lock list, and at the step 36, the transaction controller 14 resumes the arithmetic operation of the transaction that has been blocked because a lock for data related to the request was not acquired.

The process proceeds to the step P37 just as the step P25 or P35 branched to the No side after the step P26 or P36.

At the step P27, the active program AP1 receives the data item and the update content of the data, which has been updated only at the current site, from the DBMS10, and puts them at the bottom of the update content queue (P28). If there is not data that has been updated at this site, nothing is done at the step 37.

In any case, subsequent to the step 27 or 28, or after the step P37, the active program AP1 moves to the next site of circulation according to the list of addresses. The process described above is repeated also at that site.

When each DBMS executes a transaction process at the request of a client at its own site, locks are used, the process of a transaction by a data manipulation request received from a client at some site is executed in parallel with the processes of transactions TR1˜TR4 at the respective sites. Those conditions are the same as in the first embodiment.

Then, the active program AP1 is circulated in the order of site 1→site 2→site 3→site 4→site 1. On the same premise as in the first embodiment that data A, B and C are held at all sites 1˜4, the transactions TR1˜TR4 are executed, which consist of the same steps as those in the first embodiment.

More specifically, in a transaction TR1 that the site 1 receives from a client, an update operation WA1 on data A is carried out, in a transaction TR2 that the site 2 receives from a client, an update operation WA2 on data A and an update operation WB1 on data B are carried out, in a transaction TR3 that the site 3 receives from a client, a read operation RC1 on data C and an update operation WA3 on data A are carried out, and in a transaction TR4 that the site 4 receives from a client, an update operation WB2 on data B and au update operation WC1 on data C are performed.

Under the above conditions, the active program AP1 moves to site 1 at time t1. At this time, if we suppose that the lock list in FIG. 8 is empty, when the site 1 requests the active program AP1 to set a lock on data A to perform the update operation WA1, the site 1 succeeds in setting a lock, and the DBMS at the site 1 starts the transaction TR1 corresponding to this lock.

At the same time, also at site 3, a read operation RC1 can be executed on data C, which does not require a lock. The process is blocked at other sites because a lock is required.

These are the same as in the first embodiment.

When the active program AP1 moves to site 2 at time t2, the site 2 requests the active program AP1 to lock data A and B to execute the update operations WA2 and WB1, but data A has already been locked, the site 2 receives a message of failure to acquire a lock. Therefore, the transaction TR2 remains blocked.

At this time, only data B can be locked, but a lock is not set. Even if the site 2 has succeeded in acquiring a lock on data B ahead of data A, the lock on data B aborts. If only data B is locked, inconveniences arise, such as an increased possibility of a dead lock occurring in a site or between sites. Therefore, it will be efficient to collectively acquire a series of locks necessary for the execution of one transaction, and not to acquire only some of locks when necessary locks cannot be acquired collectively.

When the active program AP1 moves at time t3 to site 3, the site 3 requests the active program AP1 to lock data A to execute the update operation WA3 of the transaction TR3, but because data A has already been locked as shown on the lock list, receives a message of failure to acquire a lock.

Then, when the active program AP1 moves to site 4 at time t4, the site 4 requests the active program AP1 to lock data B and C to execute the update operations WB2 and WC1 of the transaction TR4, and succeeds in setting a lock, and the DBMS at the site 4 starts the transaction TR4.

Subsequently, at time t5, the active program AP1 moves again to site 1. The process by the active program AP1 in the second round of circulation begins here to be executed.

The site 1 has completed the transaction TR1, and a local update of data A has been finished.

Therefore, the site 1 adds the update content of data A to the update content queue of the active program AP1. At the same time, the lock on data A is removed from the lock list. At this point in time, a new transaction other than the transaction TR1 is likely to be generated at a data manipulation request of a client at the site 1; however, for simplicity's sake, it is supposed that a new transaction is not generated. This applies to the subsequent sites of the active program's circulation.

At time t6, the active program AP1 moves to site 2.

At a request of the active program AP1, the site 2 updates data A in accordance with the update operation WA1 of the transaction TR1, and requests the active program AP1 to lock data A and B, but because data B has already been locked, receives a message of failure to lock data B. Only data A is locked successfully, but the failure to lock data B aborts the lock on data A.

At time t7, the active program AP1 moves to site 3.

At a request of the active program AP1, the site 3 updates data A in accordance with the update operation WA1 of the transaction TR1. Further, the site 3 requests the active program AP1 to lock data A to execute the transaction TR3. Because the contents of the lock list changed from the case mentioned above, the lock is placed on data A is successfully this time, and transaction TR3 is started.

At time t8, the active program AP1 moves to site 4.

At a request of the active program AP1, the site 4 updates data A in accordance with the update operation WA1 of the transaction TR1. By this update, the result of the update operation WA1 on data A is reflected in the data storage units at all sites, and the tuple for the update operation WA1 is removed from the update contents queue.

By this point in time, the site 4 has completed the transaction TR4, and the local update operations WB2 and WC1 on data B and C have been finished.

The site 4 adds the contents of the update operations WB2 and WC1 to the update content queue in the active program AP1. Further, the locks on the data B and C are removed from the lock list.

At time t9, when the active program AP1 moves to site 1 for the third time, the site 1, in response to a request from the active program AP1, updates data B and C in accordance with to the update operations WB2 and WC1 of the transaction TR4. The process by the active program AP1 in the third round of circulation begins here to be executed.

Then, when the active program AP1 moves to site 2 at time t10, the site 2, in response to a request from the active program AP1, update data B and C in accordance with the update operations WB2 and WC1 of the transaction TR4.

Further, to execute the transaction TR2, the site 2 requests the active program AP1 to lock data A and B, but because data A has already been locked, receives a message of failure to lock. On account of this, the lock successfully placed on data B aborts.

At time t11, the active program AP1 moves to site 3.

In response to a request from the active program AP1, the site 3 updates data B and C in accordance with the update operations WB2 and WC1 of the transaction TR4. Thus, the contents of the update operations WB2 and WC1 by the site 4 have been reflected in the data storage units at all sites, and therefore the tuples of the update operations WB2 and WC1 are removed from the update contents queue.

At this point in time, the site 3 has completed the transaction TR3 in response to a data manipulation request that the site 3 itself received from a client, and a local update of data A corresponding to the update operation WA3 has been finished.

Accordingly, the site 3 adds the contents of an update content of data A corresponding to the update operation WA3 to the update contents queue of the active program AP1. Also, the lock on data A is removed from the lock list.

When the active program AP1 moves to site 4 at execute a process at time t12, the site 4, in response to a request from the active program AP1, updates data A in accordance with the update operation WA3 of the transaction TR.

When the active program AP1 moves to site 1 to execute a process at time t13, the process in the fourth round of its circulation begins here to be executed.

The site 1, in response to a request from the active program AP1, updates data A according to the update operation WA3 of the transaction TR3.

If the content of an update operation is simply an overwrite operation of data, the update operations of WA1, WA2 and WA3 need not be executed on the same data separately, but the final value of data (the result of WA3 in this case) may only be written over the first value to secure the consistency of data. Nevertheless, this is by no means a general practice, and because it is required to secure the consistency of data as early as possible, the data consistency is ensured at each update operation. To cite an example, when the value of data is an integer and WA1, WA2, and WA3 represent increments, if the last update operation is only performed, the final value of data may be different.

Subsequently, when the active program AP1 moves to site 2 at time t14, the site 2, in response to a request from the active program AP1, updates data A in accordance with the update operation WA3 of the transaction TR3. Thus, the contents of the update operation WA3 are reflected in the data storage units at all sites, and therefore the tuple corresponding to the update operation WA3 is removed from the update contents queue. At this time, the update contents queue becomes empty.

At site 2, because the transaction TR2 remains unprocessed, the site 2 at this moment requests the active program AP1 to lock data A and B to execute the update operations WA2 and WB1 of the transaction TR2. Both requests are acceded and locks are set successfully, and the transaction begins to be executed.

The active program AP1 moves to site 3 at time t15, but nothing takes place at site 3.

Similarly, neither when the active program moves to site 4 at time t16 nor when the active program moves to site 1 at time t17, does the active program AP1 execute any new process.

When the active program AP1 moves to site 2 at time t18, by this time, the transaction TR2 has been completed at site 2, and local updates of data A and B according to the update operations WA2 and WB1 have been finished.

The site 2 adds the update contents of data A and B in accordance with the update operations WA2 and WB1 to the update contents queue. Also, the locks on data A and B are removed from the lock list.

When the active program AP1 moves to site 3 at time t19, the site 3, complying with the request from the active program AP1, updates data A and B in accordance with the update operations WA2 and WB1 of the transaction TR2 to ensure the consistency of data A and B.

Similarly at any other subsequent times, the active program AP1, at site 4 at time t20 and at site 1 at time t21, updates data A and B in accordance with the update operations WA2 and WB1 of the transaction TR2 to thereby ensure the consistency of data.

By the updates at site 1 at time 21, the contents of the update operations WA2 and WB1 of the transaction TR2 are reflected in the data storage units at all sites, and therefore the related tuples are removed from the update contents queue. The update contents queue of the active program AP1 thus becomes empty, but the active program AP1 continues to circulate through the sites 1˜4 to cope with new transactions that take place.

By the execution procedure described above, the serialized order of the execution of transactions is site 1→site 4→site 3→site 2, by which the consistency of the database is preserved.

According to the second embodiment, the active program's rounds of circulation are greater than in the first embodiment until all transactions TR14 are finished and the consistency of data in accordance with the update operations is secured. However, the transaction processes at the respective sites, the circulation of the active program AP1 and updates of data are carried out concurrently, which brings about higher degrees of transaction concurrency and greater throughputs.

Effects of Second Embodiment

According to the present invention, effects can be obtained which are substantially equal to those of the first embodiment.

Furthermore, in the second embodiment, the granularity of locks is made smaller and the transaction concurrency is improved, making it possible to obtain a significant increase in throughput.

Other Modes of Embodiment

In the first and second embodiments, description has been made with reference to examples of relational model, but the present invention can be used in database management systems of data models other than a relation model, such as hierarchy, network, and object-oriented models.

The present invention can be applied to a case where replicas of files are distributed, and update requests are accepted at the respective sites in parallel.

When there are multiple requests to update the same data item in the update contents queue, the updates can be handled not more than once by so-called optimization, that is, by minimizing access cost in the enquiry process.

In the second embodiment mentioned above, a lock was placed on each item of data, but it is easy to realize an arrangement that locks are placed on respective data groups, respective tables or respective table groups.

In the first and second embodiments, two-phase locking was used, but in a case where data is stored in the update contents queue shown in FIG. 5 until a read operation and all the operations included in one transaction are continuously put in the update contents queue, because a schedule of operations on data in contention in each DBMS is completely fixed and strictly specified by the update contents queue, concurrency control is implemented by a method similar to a so-called timestamp algorithm. Therefore, in this case, all sites, including the site that received a data manipulation request from a client, carry out transactions in accordance with the schedule, for which reason locks are not required; therefore dead locks do not occur.

As has been described, according to the present invention, it is possible to provide a distributed database with improved toughness, reduced communication traffic and less delay.

What is claimed is:

1. A distributed database system containing a plurality of databases to store data and a plurality of servers each having at least one said database, and enabling an active program to move in a specified-sequence among said servers,
wherein at least two servers have jointly said data as a common-data respectively, and each said server comprising:
a tuple generating means to, based on data update request from a client connected to the server, generate a self-data-tuple which consists a specification information for specifying a said data to be updated, and a process information indicating process contents of said data;
a tuple attaching means to attach said self-data-tuple to said active program;
an update process means to perform each data update process on database at its own side, based on specification information and process information in said self-data-tuple and in other-data-tuple which is generated by other server and red out from said active program;
and an update information adding means to add, an update information expressing the end of said data update process corresponding to said other-data-tuple, to said other-data-tuple.

2. A distributed database system according to claim 1, wherein each said server further comprises a tuple deleting means to delete said other-data-tuple from the active program after judged by itself that all said update information corresponding to all of the said other servers have been written into the other-data-tuple.

3. A distributed database system according to claim 1,
wherein each said server further comprises,
a lock information attaching means to attach a lock information regarding said common-data to be update, to said active program before said self-data-tuple corresponding to the said common-data is generated;
and a transfer means to transfer said active program to next said server when the said lock information is attached.

4. A distributed database system according to claim 1, wherein said active program contains an access table storing access information of all said servers, and said specified-sequence is an storing-order of access information.

5. A distributed database system according to claim 1, wherein said data update process is any of a data adding process, a data changing process and a data deleting process.

6. A distributed database system according to claim 1, wherein, when said update process means has judged that said database at its own side has no data corresponding to said specification information in said other-data-tuple, said update information adding means adds said update information to said other-data-tuple.

7. A distributed database system according to claim 6, wherein each said server further comprises a tuple deleting means to delete said other-data-tuple from the active program after judged by itself that all said update information corresponding to all of the said other servers have been written into the other-data-tuple.

8. A distributed database system according to claim 6, wherein each said server further comprises,
a lock information attaching means to attach a lock information regarding said common-data to be update, to said active program before said self-data-tuple corresponding to the said common-data is generated;
and a transfer means to transfer said active program to next said server when the said lock information is attached.

9. A distributed database system containing a plurality of databases each storing the same common-data and a plurality of servers each having at least one said database, and enabling an active program to move in a specified-sequence among said servers,
wherein each said server comprising:
a tuple generating means to, based on a data update request from a client connected to the server, generate a self-data-tuple which consists a specification information for specifing a said common-data to be updated, and a process information indicating process contents of said common-data;
a tuple attaching means to attach said self-data-tuple to said active program;
a update process means to perform each data update process on database at own side, based on specification information and process information in said self-data-tuple and in other-data-tuple which is generated by other server and red out from said active program;
and a update information adding means to add, a update information expressing the end of said data update process corresponding to said other-data-tuple, to the said other-data-tuple.

10. A distributed database system according to claim 9, wherein each said server further comprises a tuple deleting means to delete said other-data-tuple from the active program after judged by itself that all said update information corresponding to all of the said other servers have been written into the other-data-tuple.

11. A distributed database system according to claim 9,
wherein each said server further comprises,
a lock information attaching means to attach a lock information regarding said common-data to be update, to said active program before said self-data-tuple corresponding to the said common-data is generated;
and a transfer means to transfer said active program to next said server when the said lock information is attached.

12. A distributed database system according to claim 9, wherein said active program contains an access table storing access information of all said servers, and said specified-sequence is an storing-order of access information.

13. A distributed database system according to claim 9, wherein said data update process is any of a data adding process, a data changing process and a data deleting process.
